(19) United States
(12) Patent Application Publication
(10) Pub. No.: US 2025/0020920 A1
(43) Pub. Date: Jan. 16, 2025

(54) MULTI-AXIS MIRROR FOR HEAD UP DISPLAY

(71) Applicant: Panasonic Automotive Systems Company of America, Division of Panasonic Corporation of North America, Peachtree City, GA (US)

(72) Inventor: JACOB MCHENRY, FAYETTEVILLE, GA (US)

(21) Appl. No.: 18/762,880

(22) Filed: Jul. 3, 2024

Related U.S. Application Data
(60) Provisional application No. 63/525,790, filed on Jul. 10, 2023.

(51) Int. Cl. G02B 27/01; G02B 26/08; G02B 26/10

(52) U.S. Cl. CPC G02B 27/0101; G02B 26/0816; G02B 26/101; G02B 27/0179; G02B 2027/0187

(57) ABSTRACT

A head up display arrangement presents a virtual image to a human driver of a motor vehicle. A picture generation unit emits a light field. A mirror is mounted on a gimbal such that the mirror is rotatable about both a first axis and a second axis oriented perpendicular to the first axis. The mirror reflects the light field such that the reflected light field is again reflected by a windshield of the motor vehicle and is visible to the human driver as the virtual image. First and second motors rotate the mirror about the first axis and second axis, respectively. An electronic processor controls the first motor and/or the second motor dependent upon a detected position of the eyes of the human driver such that the virtual image remains visible to the human driver over a range of motion of the driver's head.

### CROSS-REFERENCED TO RELATED APPLICATIONS

This application claims benefit of U.S. Provisional Application No. 63/525,790, filed on Jul. 10, 2023, the disclosure of which is hereby incorporated by reference in its entirety for all purposes.

### BACKGROUND OF THE INVENTION

### 1. Field of the Invention.

The present invention relates to a head up display (HUD) of a motor vehicle.

### 2. Description of the Related Art.

A head up display emits light that reflects from the front windshield to be

seen by the driver. The light appears to come from a virtual image in front of the driver and in front of the windshield. This type of head up display is currently commercially available.

Conventional head up displays create the virtual image by first using a display or picture generation unit to create an image. Next, the light from the image is reflected from one or more mirrors. Next, the light from the mirrors is directed up to the windshield and is then reflected from the windshield towards the driver. The mirrors are designed and positioned relative to the display so that the light seen by the driver, which is reflected from the windshield, appears to come from a virtual image that is outside of the vehicle. The mirrors and display are typically contained in a package that occupies a volume beneath the top surface of the dashboard.

### SUMMARY OF THE INVENTION

The invention may provide a bigger eyebox for a head up display in the automotive field by using a multi-axis mirror design. The mirror can rotate both on a first axis, which is horizontal, and on a second axis that is perpendicular to the first axis and that bisects the mirror. By rotating the mirror about both these axes, the eyebox can be moved to the driver's head position. If integrated with an eye tracking system (ETS) or a driver monitoring system (DMS), this mirror adjustment can be done on the fly by the vehicle systems. Alternatively, this mirror adjustment can be performed with a manual control device, such as a switch.

The invention may enable the mirror in the Head Up Display to move around two axes in case the driver moves their head while driving or leans to the left or right. Currently the eyebox in a HUD is either completely fixed or horizontally fixed and somewhat small, so if the driver moves their head out of the eyebox they cannot see the virtual image in the HUD. This invention essentially gives the perception of a larger eyebox to account for different driving positions.

The invention comprises, in one form thereof, a head up display arrangement for presenting a virtual image to a human driver of a motor vehicle. The arrangement includes a picture generation unit emitting a light field. A mirror is mounted on a gimbal such that the mirror is rotatable about both a first axis and a second axis oriented perpendicular to the first axis. The mirror reflects the light field such that the reflected light field is again reflected by a windshield of the motor vehicle and is visible to the human driver as the virtual image. A first motor is coupled to the mirror and rotates the mirror about the first axis. A second motor is coupled to the mirror and rotates the mirror about the second axis. An eye tracking system detects a position of the eyes of the human driver. An electronic processor is communicatively coupled to the first motor, the second motor and the eye tracking system. The electronic processor controls the first motor and/or the second motor dependent upon the detected position of the eyes of the human driver such that the virtual image remains visible to the human driver over a range of motion of a head of the human driver.

The invention comprises, in another form thereof, a method for presenting a virtual image to a human driver of a motor vehicle, including emitting a light field. A mirror is mounted on a gimbal such that the mirror is rotatable about both a first axis and a second axis oriented perpendicular to the first axis. The mirror is used to reflect the light field such that the reflected light field is again reflected by a windshield of the motor vehicle and is visible to the human driver as the virtual image. A position of the eyes of the human driver is detected. The mirror is rotated about the first axis and the second axis dependent upon the detected position of the eyes of the human driver such that the virtual image remains visible to the human driver over a range of motion of a head of the human driver.

The invention comprises, in yet another form thereof, a head up display arrangement for presenting a virtual image to a human driver of a motor vehicle. The arrangement includes a picture generation unit emitting a light field. A mirror is mounted on a gimbal such that the mirror is rotatable about both a first axis and a second axis oriented perpendicular to the first axis. The mirror reflects the light field such that the reflected light field is again reflected by a windshield of the motor vehicle and is visible to the human driver as the virtual image. A first motor is coupled to the mirror and rotates the mirror about the first axis. A second motor is coupled to the mirror and rotates the mirror about the second axis. A first manual control device is communicatively coupled to the first motor and enables the human driver to control the first motor. A second manual control device is communicatively coupled to the second motor and enables the human driver to control the second motor.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic side view of one embodiment of a motor vehicle including a HUD arrangement of the present invention.

FIG. 2 is a schematic view of the rotatable mirror of the HUD arrangement of FIG. 1.

FIG. 3 is a flow chart of one embodiment of a method of the present invention for presenting a virtual image to a human driver of a motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

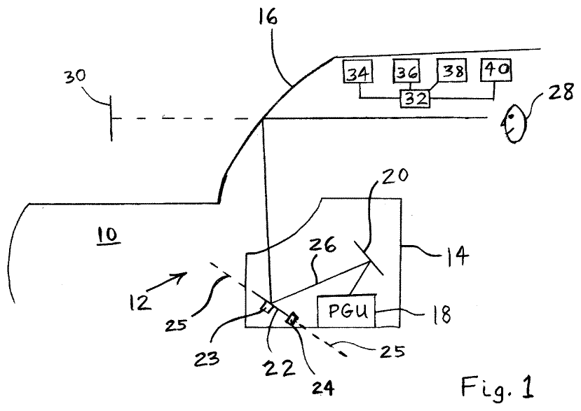

FIG. 1 illustrates one embodiment of a motor vehicle 10 including a head up display (HUD) arrangement 12 of the present invention, including a HUD unit 14 and a windshield 16. HUD unit 14 may include a picture generation unit (PGU) 18, a fold mirror 20, and a second mirror 22. A vertical displacement motor 23 may rotate mirror 22 about a horizontal axis that is perpendicular to the page of FIG. 1. A horizontal displacement motor 24 may rotate mirror 22 about axis 25, which is perpendicular to the axis about which motor 23 rotates mirror 22. Axis 25 may also be coplanar with mirror 22. Arrangement 12 may further include an electronic processor 32 in communication with each of an eye tracking system (ETS) 34, a driver monitoring system (DMS) 36, a first manual control device 38 for controlling motor 23, and a second manual control device 40 for controlling motor 24. Electronic processor 32 may also be in direct communication with, and control the operation of, each of motor 23 and motor 24. Both eye tracking system (ETS) 34 and driver monitoring system (DMS) 36 may be considered an “eye detecting system” as the term is used herein.

During use, a light field 26 from PGU 18, after being first reflected by mirror 20, may be reflected by mirror 22 and then by windshield 16 such that the reflection is visible to a driver 28 as a virtual image 30. In order to move virtual image 30 such that the eyes of driver 28 are in position to see virtual image 30, mirror 22 may be rotated by motor 23 about the axis perpendicular to the page of FIG. 1, and/or mirror 22 may be rotated by motor 24 about axis 25. More particularly, if eye tracking system (ETS) 34 or driver monitoring system (DMS) 36 determines that the eyes of driver 28 are horizontally displaced from the eyebox (e.g., driver 28 has moved his head side-to-side to the left or right), then electronic processor 32 may cause horizontal displacement motor 24 to rotate mirror 22 about axis 25 to thereby move virtual image 30 to the left or right such that the eyes of driver 28 are in the eyebox, and driver 28 can see virtual image 30. Alternatively, driver 28 can use manual control device 40 to cause motor 24 to rotate mirror 22 about axis 25 to thereby move virtual image 30 to the left or right such that the eyes of driver 28 are in the eyebox, and driver 28 can see virtual image 30. On the other hand, if eye tracking system (ETS) 34 or driver monitoring system (DMS) 36 determines that the eyes of driver 28 are vertically displaced from the eyebox (e.g., driver 28 has moved his head up or down, or is too tall or short for the existing eyebox position), then electronic processor 32 may cause vertical displacement motor 23 to rotate mirror 22 about the axis that is perpendicular to the page of FIG. 1 to thereby move virtual image 30 up or down such that the eyes of driver 28 are in the eyebox, and driver 28 can see virtual image 30. Alternatively, driver 28 can use manual control device 38 to cause motor 23 to rotate mirror 22 about the axis perpendicular to the page of FIG. 1 to thereby move virtual image 30 up or down such that the eyes of driver 28 are in the eyebox, and driver 28 can see virtual image 30.

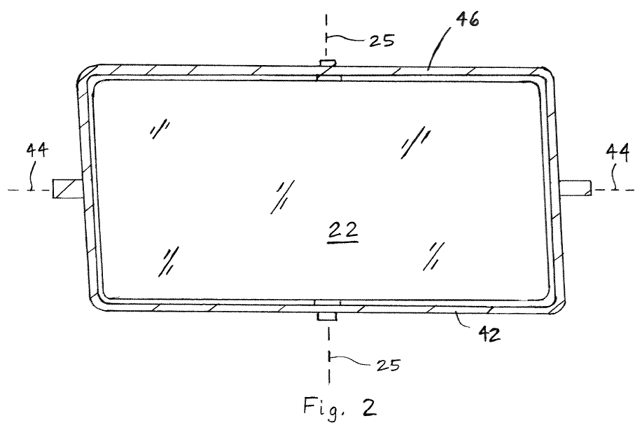

FIG. 2 further illustrates mirror 22 and its ability to rotate about two different perpendicular axes. Mirror 22 is mounted on a gimbal 42, which enables mirror 22 to rotate about both axis 25 and an axis 44 that is perpendicular to the page of FIG. 1. A frame 46 of gimbal 42 may rotate along with mirror 22 about axis 44 when actuated by motor 23. However, frame 46 may remain stationary when mirror rotates about axis 25 when actuated by motor 24.

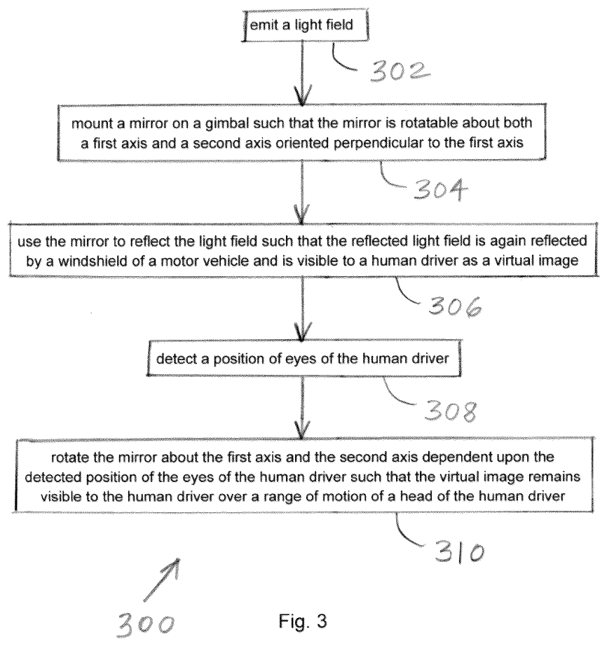

FIG. 3 illustrates one embodiment of a method 300 of the present invention for presenting a virtual image to a human driver of a motor vehicle. In a first step 302, a light field is emitted. For example, PGU 18 may emit a light field 26.

Next, in step 304, a mirror may be mounted on a gimbal such that the mirror is rotatable about both a first axis and a second axis oriented perpendicular to the first axis. For example, mirror 22 may be mounted on gimbal 42, which enables mirror 22 to rotate about both axis 25 and an axis 44 that is perpendicular to the page of FIG. 1.

In a next step 306, the mirror is used to reflect the light field such that the reflected light field is again reflected by a windshield of the motor vehicle and is visible to the human driver as the virtual image. For example, light field 26 may be reflected by mirror 22 and then by windshield 16 such that the reflection is visible to a driver 28 as a virtual image 30.

In step 308, a position of the eyes of the human driver is detected. For

example, eye tracking system (ETS) 34 or driver monitoring system (DMS) 36 may determine a location of the eyes of driver 28.

In a final step 310, the mirror is rotated about the first axis and the second axis dependent upon the detected position of the eyes of the human driver such that the virtual image remains visible to the human driver over a range of motion of a head of the human driver. For example, in order to move virtual image 30 such that the eyes of driver 28 remain able to see virtual image 30 after driver 28 has moved his head to a position determined in step 308, mirror 22 may be rotated by motor 23 about axis 44, and mirror 22 may be rotated by motor 24 about axis 25.

Although axes 25, 44 are described herein as being oriented perpendicular to each other, it is to be understood that it may be possible to implement the invention with the mirror having two rotational axes that are not perpendicular to each other. That is, it may be possible to move the eyebox to a desired location by rotating the mirror about two axes that are not perpendicular to each other.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A head up display arrangement for presenting a virtual image to a human driver of a motor vehicle, the arrangement comprising:
a picture generation unit configured to emit a light field;
a mirror mounted on a gimbal such that the mirror is rotatable about both a first axis and a second axis, the mirror being configured to reflect the light field such that the reflected light field is again reflected by a windshield of the motor vehicle and is visible to the human driver as the virtual image;
a first motor coupled to the mirror and configured to rotate the mirror about the first axis;
a second motor coupled to the mirror and configured to rotate the mirror about the second axis;
an eye detecting system configured to detect a position of the eyes of the human driver; and
an electronic processor communicatively coupled to the first motor, the second motor and the eye detecting system, the electronic processor being configured to control the first motor and/or the second motor dependent upon the detected position of the eyes of the human driver such that the virtual image remains visible to the human driver over a range of motion of a head of the human driver.

2. The arrangement of claim 1 wherein the second axis is oriented perpendicular to the first axis.

3. The arrangement of claim 1 wherein the first axis is horizontal and the second axis is coplanar with the mirror.

4. The arrangement of claim 3 wherein the gimbal includes a frame that rotates with the mirror as the mirror rotates about the first axis.

5. The arrangement of claim 4 wherein the frame does not rotate with the mirror as the mirror rotates about the second axis.

6. The arrangement of claim 1 wherein the eye detecting system comprises an eye tracking system.

7. The arrangement of claim 1 wherein the eye detecting system comprises a driver monitoring system.

8. A method for presenting a virtual image to a human driver of a motor vehicle, the method comprising:
emitting a light field;
mounting a mirror on a gimbal such that the mirror is rotatable about both a first axis and a second axis oriented perpendicular to the first axis:
using the mirror to reflect the light field such that the reflected light field is again reflected by a windshield of the motor vehicle and is visible to the human driver as the virtual image;
detecting a position of the eyes of the human driver; and
rotating the mirror about the first axis and the second axis dependent upon the detected position of the eyes of the human driver such that the virtual image remains visible to the human driver over a range of motion of a head of the human driver.

9. The method of claim 8 wherein the first axis is horizontal.

10. The method of claim 9 wherein the second axis is coplanar with the mirror.

11. The method of claim 10 wherein the gimbal includes a frame that rotates with the mirror as the mirror rotates about the first axis.

12. The method of claim 11 wherein the frame does not rotate with the mirror as the mirror rotates about the second axis.

13. The method of claim 8 wherein the position of the eyes is detected by an eye tracking system.

14. The method of claim 8 wherein the position of the eyes is detected by a driver monitoring system.

15. A head up display arrangement for presenting a virtual image to a human driver of a motor vehicle, the arrangement comprising:
a picture generation unit configured to emit a light field;
a mirror mounted on a gimbal such that the mirror is rotatable about both a first axis and a second axis oriented perpendicular to the first axis, the mirror being configured to reflect the light field such that the reflected light field is again reflected by a windshield of the motor vehicle and is visible to the human driver as the virtual image;
a first motor coupled to the mirror and configured to rotate the mirror about the first axis;
a second motor coupled to the mirror and configured to rotate the mirror about the second axis;
a first manual control device communicatively coupled to the first motor and positioned and configured to enable the human driver to control the first motor; and
a second manual control device communicatively coupled to the second motor and positioned and configured to enable the human driver to control the second motor.

16. The arrangement of claim 15 wherein the first axis is horizontal.

17. The arrangement of claim 16 wherein the second axis is coplanar with the mirror.

18. The arrangement of claim 17 wherein the gimbal includes a frame that rotates with the mirror as the mirror rotates about the first axis.

19. The arrangement of claim 18 wherein the frame does not rotate with the mirror as the mirror rotates about the second axis.

20. The arrangement of claim 15 wherein the mirror comprises a first mirror, the arrangement further comprising a second mirror configured to reflect the light field from the picture generation unit toward the first mirror.
